(19) United States
(12) Patent Application Publication
(10) Pub. No.: US 2016/0007069 A1
(43) Pub. Date: Jan. 7, 2016

(54) ENHANCED MOBILE VIDEO PLATFORM

(71) Applicant: CV Studios Entertainment, Inc., Palm Springs, CA (US)

(72) Inventors: Carole Sumner Krechman, Rancho Mirage, CA (US); Leanna Bonamici, Palm Desert, CA (US)

(21) Appl. No.: 14/843,101

(22) Filed: Sep. 2, 2015

Related U.S. Application Data
(63) Continuation-in-part of application No. PCT/US2014/047704, filed on Jul. 22, 2014.
(60) Provisional application No. 61/858,922, filed on Jul. 26, 2013.

(51) Int. Cl. H04N 21/414; H04N 21/44; H04N 21/4722; H04N 21/482; H04N 21/238; H04N 21/485; H04N 21/81; H04N 21/258

(52) U.S. Cl. CPC H04N 21/41407; H04N 21/812; H04N 21/8133; H04N 21/44004; H04N 21/25883; H04N 21/4825; H04N 21/238; H04N 21/4856; H04N 21/4722

(57) ABSTRACT

An enhanced mobile video platform is shown and described. In particular, the architecture and features of the mobile video platform provides users and content providers (e.g., filmmakers, directors, etc.) with an enhanced experience. For example, pre-buffering of video content based on displayed video lists (e.g., thumbnails) provides for less user wait-time when selecting a desired video to play. Also, forcing the app to play videos in “landscape” mode provides an environment that more easily displays videos in their intended “widescreen” format, without requiring the user to properly rotate their mobile device (or worry about having the videos resort to “portrait” mode while moving their mobile device or placing it on a horizontal surface). In addition to entertainment, the enhanced mobile video platform can also be used for enhanced dissemination of business or education content to users. Other features and aspects of the enhanced mobile video platform are also described herein.

### RELATED APPLICATIONS

The present application is a continuation-in-part (CIP) of PCT Application No. PCT/US2014/047704, filed by Krechman et al. on Jul. 22, 2014, entitled: ENHANCED MOBILE VIDEO PLATFORM, which claims priority to U.S. Provisional Application No. 61/858,922, filed by Krechman et al. on Jul. 26, 2013, entitled: ENHANCED MOBILE VIDEO PLATFORM, the contents of each of which being incorporated by reference herein.

### TECHNICAL FIELD

The present invention relates generally to mobile applications, and, more particularly, to enhanced user experience in a mobile video platform.

### BACKGROUND

Online websites and mobile applications (“apps”) provide mobile device users with a plethora of functionalities and entertainment options. One particular realm of entertainment is video, where filmmakers (producers, directors, etc.) upload their films to an online database to be viewed by users on their user devices (e.g., desktop computers, mobile devices such as phones, tablets, etc.).

Many video playing programs (apps, websites, etc.) are currently available to users, such as YOUTUBE. These video platforms are generally standard in format, allowing the uploading (submitting) and downloading (playing) of videos, sharing of the videos, commenting on the videos, etc., in accordance with standard social media environments as are well understood in the art. However, the video platforms available today lack many features that would otherwise enhance the user's experience. In particular, video platforms today are often based on sharing “any” video, and are neither catered nor well-suited to specific audiences and/or services.

### SUMMARY

An enhanced mobile video platform is shown and described. In particular, the architecture and features of the mobile video platform provides users and content providers (e.g., filmmakers, directors, etc.) with an enhanced experience. For example, pre-buffering of video content based on displayed video lists (e.g., thumbnails) provides for less user wait-time when selecting a desired video to play. Also, forcing the app to play videos in “landscape” mode provides an environment that more easily displays videos in their intended “widescreen” format, without requiring the user to properly rotate their mobile device (or worry about having the videos resort to “portrait” mode while moving their mobile device or placing it on a horizontal surface).

In addition to entertainment, the enhanced mobile video platform can also be used for enhanced dissemination of business or education content to users. For instance, in one embodiment, employees or students may be sent an indication (e.g., an email or a mobile “push” notification) that there is new video content available. An administrator may then be notified of the users that received the indication, and may also be notified of those that viewed the content. Moreover, the enhanced dissemination of the video may be accompanied by language considerations, such as based on a default language of the individual recipients and/or a default language of the geographical region in which the recipient is located.

Moreover, in one embodiment of business content, the video to be played is directed to a product on sale at a store location associated with the client device. In a specific implementation of this embodiment, a mobile device may be able to scan the product (e.g., a barcode, image, QR-code, etc.), and be directed to a video associated with the product (e.g., marketing, instructions, display, training, etc.).

Other features and aspects of the enhanced mobile video platform are also described herein. Furthermore, the techniques and systems herein are not limited to “mobile” playing of the video, as described herein.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example computing device;

FIG. 3 illustrates an example video adding and editing interface in accordance with one or more embodiments of the enhanced mobile video platform described herein;

FIG. 4 illustrates an example thumbnail selection interface in accordance with one or more embodiments of the enhanced mobile video platform described herein;

FIG. 5 illustrates an example related video mapping interface in accordance with one or more embodiments of the enhanced mobile video platform described herein;

FIGS. 6A and 6B illustrate example video management interfaces in accordance with one or more embodiments of the enhanced mobile video platform described herein;

FIG. 7 illustrates an example user video list interface in accordance with one or more embodiments of the enhanced mobile video platform described herein;

FIG. 8 illustrates an example user video information interface in accordance with one or more embodiments of the enhanced mobile video platform described herein;

FIG. 9 illustrates an example video play format in landscape mode in accordance with one or more embodiments of the enhanced mobile video platform described herein;

FIG. 10 illustrates an example of video buffering in accordance with one or more embodiments of the enhanced mobile video platform described herein;

FIG. 11 illustrates an example of multiple video buffering in accordance with one or more embodiments of the enhanced mobile video platform described herein;

FIG. 12 illustrates an example splash screen logo in accordance with one or more embodiments of the enhanced mobile video platform described herein;

FIG. 13 illustrates an example push notification in accordance with one or more embodiments of the enhanced mobile video platform described herein;

FIG. 14 illustrates an example of groups/categories in a first example of a business use of the enhanced mobile video platform described herein;

FIG. 15 illustrates an example of sub-menus for a group in the first example of a business use of the enhanced mobile video platform described herein;

FIG. 16 illustrates an example of a video list in the first example of a business use of the enhanced mobile video platform described herein;

FIG. 17 illustrates an example of specific video information in the first example of a business use of the enhanced mobile video platform described herein;

FIG. 18 illustrates another example of groups/categories in a second example of an educational use of the enhanced mobile video platform described herein;

FIG. 19 illustrates another example of sub-menus for a group in the second example of an educational use of the enhanced mobile video platform described herein;

FIG. 20 illustrates another example of a video list in the second example of an educational use of the enhanced mobile video platform described herein;

FIG. 21 illustrates another example of specific video information in the second example of an educational use of the enhanced mobile video platform described herein;

FIG. 22 illustrates an example simplified procedure for certain key features associated with providing an enhanced mobile video platform in accordance with one or more embodiments described herein, particularly from the perspective of a video administrator; and

FIG. 23 illustrates another example simplified procedure for certain key features associated with providing an enhanced mobile video platform in accordance with one or more embodiments described herein, particularly from the perspective of a user's video player.

### DETAILED DESCRIPTION OF EXAMPLE EMBODIMENTS

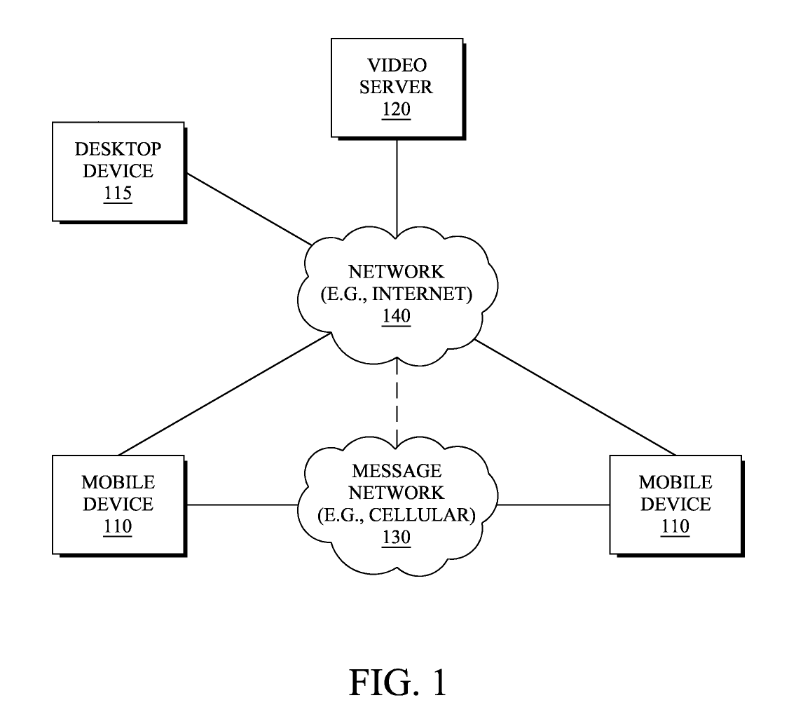

Particular embodiments may operate in, or in conjunction with, a communication network environment, such as a cellular network, the Internet, etc., including multiple network addressable systems (e.g., phone numbers, Internet Protocol (IP) addresses, etc.). FIG. 1 illustrates an example communication environment 100, in which various example embodiments may operate. Various client devices may be in communication with each other within the network 100, such as mobile devices 110 (e.g., phones, tablets, automobiles, etc.) or stationary/desktop devices 115 (e.g., personal computers, etc.). Illustratively, such communication may be via a “messaging network”, such as a cellular telephone network 130, and/or a separate or associated Internet network 140 (e.g., a WiFi network, wide area network, etc.), as described herein. One or more servers 120 (e.g., websites, databases, etc.) may also be in communication within the network 100, as also described herein. Notably, the network clouds 130/140 generally represent one or more interconnected networks, over which various systems and hosts described herein may communicate, and may comprise packet-based wide area networks (such as the Internet), private networks, wireless networks, satellite networks, cellular networks, and the like, and the view shown herein is merely illustrative.

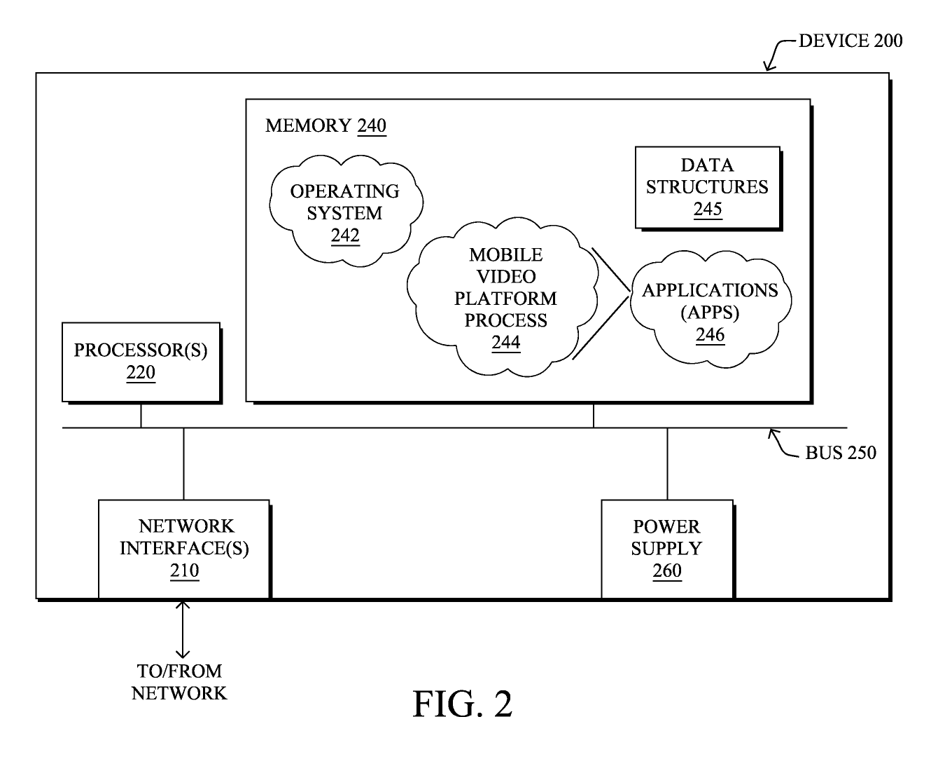

Generally, the client devices 110 and 115 and servers 120 of FIG. 1 may be operably connected to the network environment 100 via a network service provider, a is telephone service provider, a wireless carrier, or any other suitable means. Each client device and/or server may generally be a computer, computing system, or computing device including functionality for communicating (e.g., remotely) over a computer network. FIG. 2 is a schematic block diagram of an example device 200 that may be used with one or more embodiments described herein, e.g., as any of the client devices 110/115 and/or servers 120 shown in FIG. 1 above. The device may comprise one or more network interfaces 210 (e.g., wired, cellular, wireless/WiFi, etc.), at least one processor 220, and a memory 240 interconnected by a system bus 250. Also, a power supply 260 (e.g., battery, plug-in, etc.) may also supply power to the device 200.

The network interface(s) 210 contain the mechanical, electrical, and signaling circuitry for communicating data over links coupled to the network 100 (e.g., networks 130 and/or 140). The network interfaces may be configured to transmit and/or receive data using a variety of different communication protocols. Note, further, that the devices may have two different types of network connections 210, e.g., wired/physical, wireless, and/or cellular, and that the view herein is merely for illustration. Further, in one embodiment, interface 210 may also be configured as a general image input device, such as a code scanner, image detector, etc.

The memory 240 comprises a plurality of storage locations that are addressable by the processor 220 for storing software programs and data structures associated with the embodiments described herein. The processor 220 may comprise hardware elements or hardware logic adapted to execute the software programs and manipulate the data structures 245. An operating system 242 (e.g., APPLE iOS, GOOGLE ANDROID OS, MICROSOFT WINDOWS, etc.), portions of which are typically resident in memory 240 and executed by the processor, functionally organizes the device by, inter alia, invoking operations in support of software processes and/or services executing on the device. These software processes and/or services may comprise an illustrative mobile video platform process 244, in addition to one or more (other) applications or “apps” 246, which may each be configured depending upon the particular device within the network 100 (e.g., as a client device 110/115 or as a server 120), as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Mobile video platform process 244 and Apps 246 may each contain computer executable instructions executed by the processor 220 to perform various functions, as will be appreciated by those skilled in the art. For example, applications (apps) 246 may comprise one or more specific and/or integrated applications, such as a web browser to access and view content over the network 100 (e.g., MICROSOFT INTERNET EXPLORER, MOZILLA FIREFOX, APPLE SAFARI, GOOGLE CHROME, etc.). Other specific apps may comprise such feature-specific applications such as music apps, consumer product purchasing apps, travel apps, restaurant review/reservation apps, and so on.

Illustratively, the techniques described herein may be performed by hardware, software, and/or firmware, such as in accordance with the mobile video platform process 244 (e.g., a mobile app and/or desktop web browser), which may contain computer executable instructions executed by the processor 220 to perform functions relating to the techniques described herein, e.g., optionally in conjunction with other processes, apps, and/or services 246. For example, certain aspects of the techniques herein may be treated as extensions to conventional media management protocols, and as such, may be processed by similar components understood in the art that execute those protocols, accordingly.

The techniques herein provide a multi-lingual mobile app (e.g., for APPLE iPHONE devices, GOOGLE ANDROID devices, or other similar types of devices) which displays short films and videos. The app allows users to browse and watch films, and provides administrators with a web interface to manage content of the app and platform.

A core component of the platform described herein is the administrator's interface. In particular, the techniques herein provide a mobile video platform/app which will be managed by the web administrator with functionality to Add/Edit categories, videos, and Banner Ads. Videos can be listed under various genres/categories on the mobile app which will provide app users with functionality to browse, watch videos, vote for videos, add them to favorite list, share videos, etc.

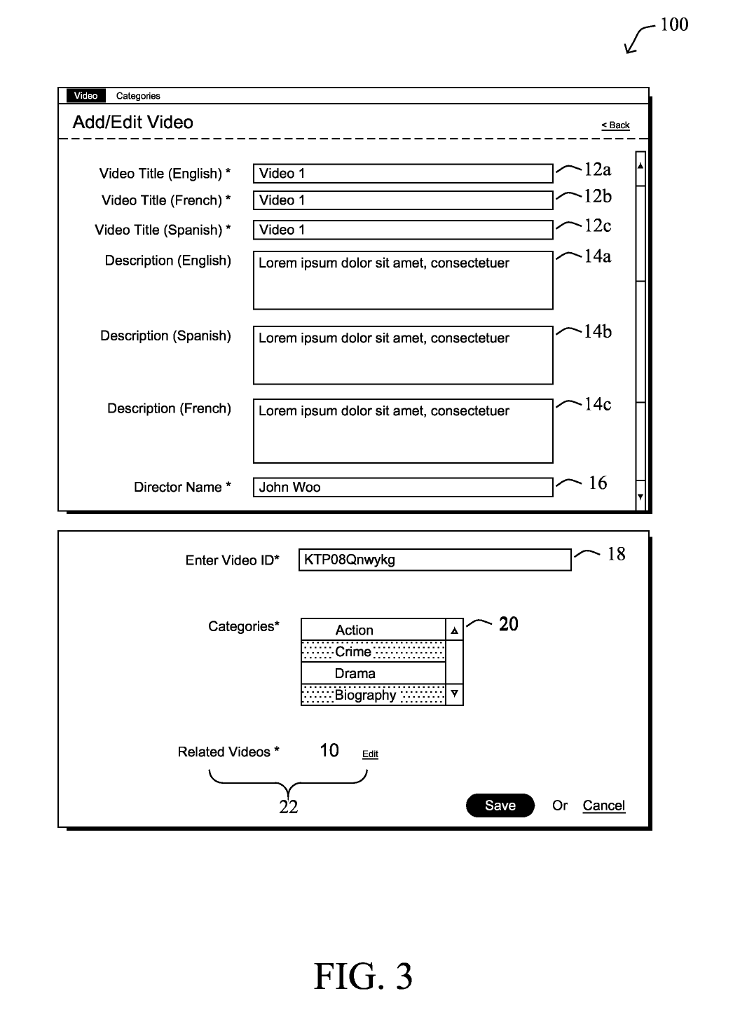

In particular, with reference to FIG. 3, an administrator (or other user with access and authority) can add videos to the platform and/or edit video information using illustrative (though notably non-limiting) interface 100, where a video's title 12 may be entered in at least a default language (e.g., English 12a), and optionally other languages (e.g., French 12b and Spanish 12c). Similarly, the administrator can add a short description 14, again in a default language and other languages (14a, b, and c). In one embodiment, other information, such as a director's name 16 may be included.

A link 18 to the video may be provided, such as in the form of a video upload or as a redirecting link to another video storage site. For example, where videos are uploaded on a client's (user's) YOUTUBE channel, a web administrator may choose videos to be displayed on the app by providing video's YOUTUBE ID to the system. (YOUTUBE is merely one example of web-based video content, and is not meant to limit the scope of the embodiments herein.) Alternatively, administrators or users will upload video (e.g., via FTP). (Note that in one embodiment, the system can display a terms and conditions page where user can accept or decline, and the user would be allowed to upload video only if he or she accepts terms and conditions. In another embodiment, a cost may be associated with uploading the video.) When deleting videos from the player platform herein, if the video was uploaded, the video may be deleted. However, if the video is a link to another site (e.g., YOUTUBE), then only the link is deleted from the database, and the video would generally still remain present at the parent storage site.

In addition, a category or genre selection 20 may also be made, such as selecting from any number of pre-populated choices (e.g., a generic list or else a specific list designated for a particular implementation of the platform). For instance, example categories may comprise action, crime, drama, biography, and so on. Also, as described below, a number of related videos 22, and the option to edit those related videos, may also be presented.

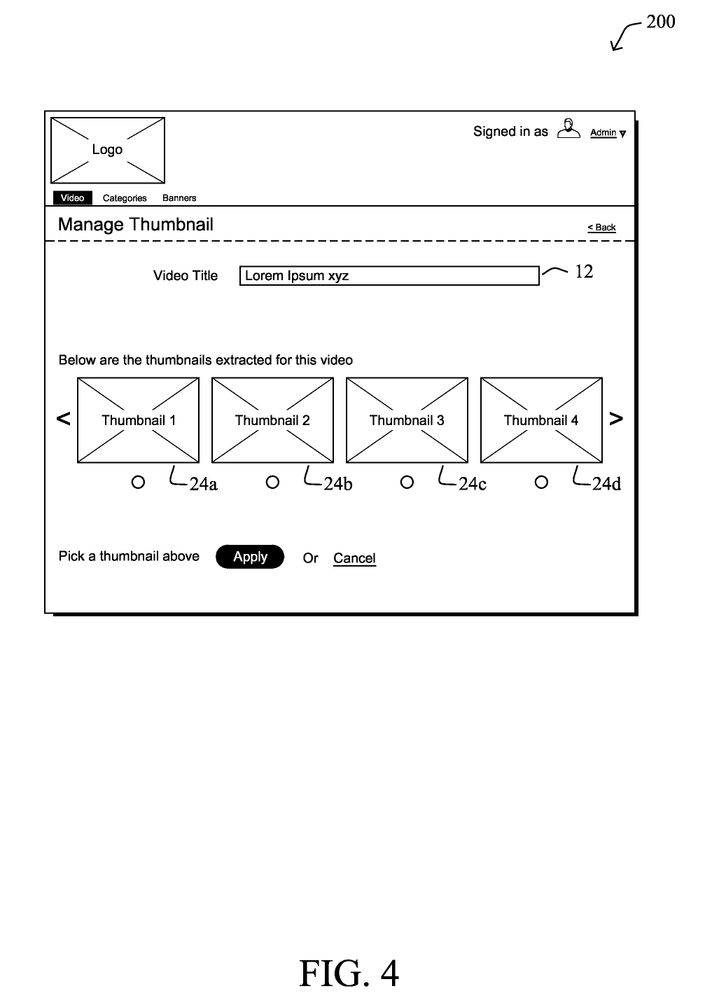

In one embodiment with reference to FIG. 4, once the video has been added, a “thumbnail” selection interface 200 may be presented to the administrator to allow the administrator to select a thumbnail 24 (e.g., 24a-24d) between a default thumbnail (e.g., set to the nth second of a video), or else some other thumbnail dynamically (e.g., other random selections) or manually selected. For example, a third party tool may extract one thumbnail (e.g., a 4:3 ratio) and another three (e.g., 16:9) ratio for every video, and the administrator or user can select from these dynamically generated thumbnails. This thumbnail 24 may be used to accompany the user's selection of the video as described below (e.g., depending upon whether a 4:3 ratio or 16:9 ratio thumbnail is called for).

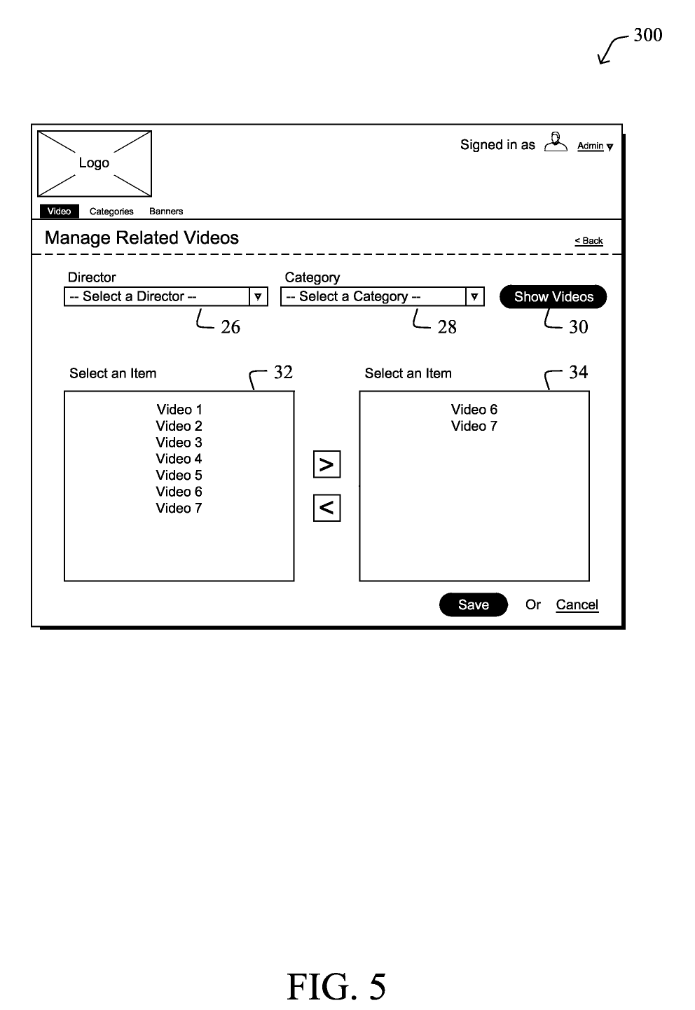

In accordance with one or more embodiments of the video platform described herein, videos entered into the platform may be associated with (mapped to) other related videos. For instance, the relation may be automated, such as based on shared directors, genres, keywords (from titles and/or descriptions), etc. However, as shown in FIG. 5, an administrator can manually enter (or at least confirm) the relations of the videos via interface 300. For instance, as shown, by entering various search criteria (e.g., director 26 and category 28), refreshing the search (button 30) may populate the un-associated title list 32 with videos meeting the filter results. For example, related videos may first be suggested based on search and/or filter criteria (e.g., limiting the results to only those meeting all entered search and/or filter criteria), and then the administrator may manually select videos he or she wishes to relate (e.g., dragging the entry from the un-associated suggestion side 32 to the associated/related side 34. Note that other methods of associating related videos are possible, and the specific example given herein is merely one illustrative technique.

Once the video is uploaded (or linked) and the information is populated, the videos become searchable to users as described below. Additionally, in one embodiment, users may receive a notification of the video, such as an email, a push notification, or other notification that a video has been added. For instance, certain users may fall within particular categories (e.g., judges, employees, team members, students, etc.), or else may have subscribed to particular videos, e.g., all, all comedy, all educational, and so on. As such, if these conditions are met, the select users may be notified, accordingly.

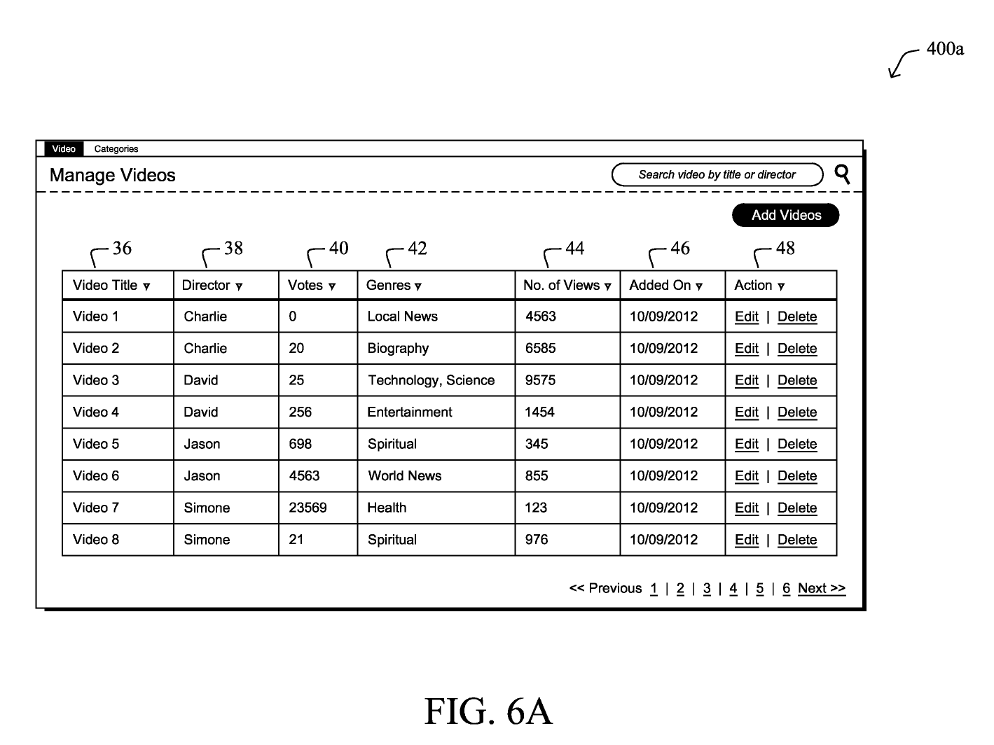

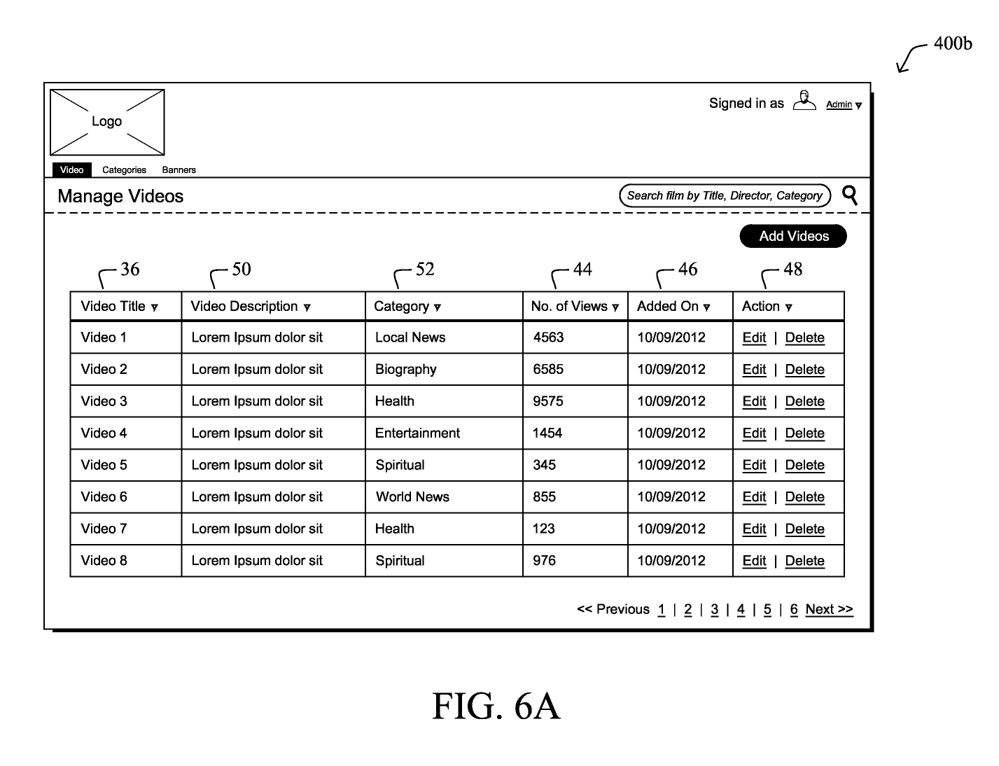

FIGS. 6A and 6B illustrate alternate views of a management portal interface 400 (and 400b, respectively), where an administrator can view and sort saved videos to the system based on video titles 36, directors 38, votes 40 (described below), genres 42, views 44, added on date 36, and so forth. From this list, the administrator may select an action 48, such as editing or deleting the corresponding video. Note that the arrangement shown in FIG. 6A is merely one example for the list of videos in the platform, and other arrangements may be used, accordingly. For instance, as shown in FIG. 6B, the director, votes, and genre fields have been replaced by a video description 50 and a category 52.

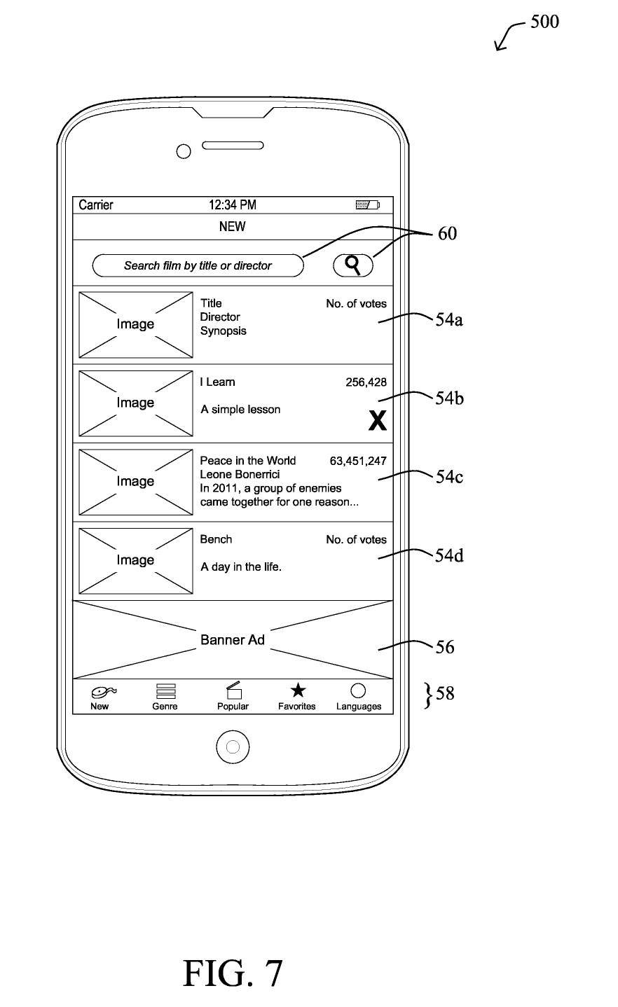

With videos stored and/or referenced within the video platform, users of the app can browse and watch videos. As shown in FIG. 7, a particular view 600 (e.g., a home page) allows users to view a list of videos 54 (e.g., 54a-54d) meeting current criteria. For instance, in one embodiment, the video list is generated based on field searching, genre or category filters, etc. In another embodiment, the most viewed and most voted videos may be shown, such as where the system automatically uploads a few top videos on the home page (or else being performed manually by an administrator). The screen 500 may comprise a search bar/field 60 that helps to focus the list of titles 54, such as auto-suggesting enabled searching, which allows users to search for members, videos by video title, directors, etc.

Information associated with each video, such as a thumbnail, title, brief description, director's name, number of votes/views/likes, favorites indications, etc., may be present, depending upon the configuration of the particular platform. For instance, where the video listing also allows for votes for the video, users can then sort videos by number of votes. Other sorts are available, such as by runtime, by date, by director, awards, genres, alphabetical, etc. In addition, other features such as a banner ad 56 (described below) and a menu bar 58 may also be present. Though not shown, other features, such as viewing a TWITTER feed through a TWITTER API and/or a FACEBOOK feed through a FACEBOOK API may also be available.

The menu bar 58 presents a number of selectable tabs that assist in presented a desired list of videos to a user. For instance, example tabs shown include “New” (recently added films), “Genre” (bringing up a list of genres to browse, e.g., action/adventure, children/family, comedy, documentary, drama, foreign, etc.), “Popular” (most viewed and/or highest votes), “Favorites” (user selected/stored favorites), and so on. Other options, such as and “Languages” (selecting a default or preferred language), general administration, login, other sort functions, etc., may be possible.

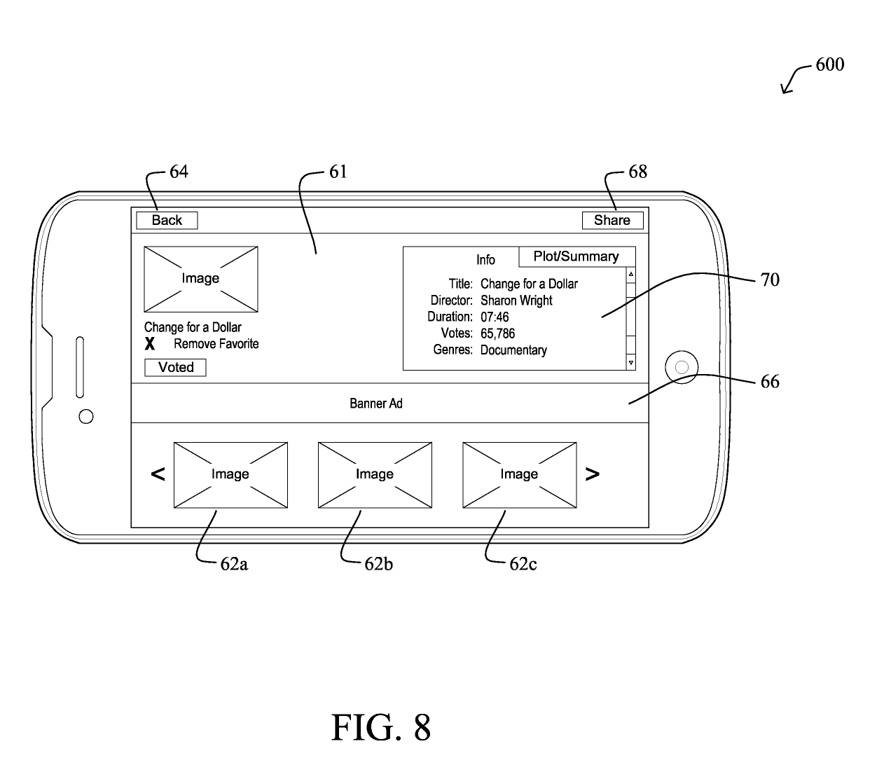

Once a particular video is initially selected from the list 500 in FIG. 7, a video details page 600 shown in FIG. 8 may then be presented to the user by the video platform app (e.g., in landscape orientation). In particular, the user has selected a video 61 whose details are shown, including a thumbnail, title, favorite status, information/summary field 70, and other information. From here, the user can play the video using the video player, and can also view details such as title, director, runtime, synopsis, and may view and post comments. Also, a related videos system can suggest similar videos 62 (e.g., 62a-62c) using keywords, manual entries, filter results, etc. (Note that in one embodiment, related videos may be displayed from the platform's database only and not any external source.) Users may also tag the video from this screen by entering a keyword which will help the system relate one video to the other and display suggestions on video details page. A traditional “Back” button 64 may return the user to the list 500 of FIG. 7, and a banner ad 66 may again be present.

Note that through “share” button 68, allows for social sharing of the video (e.g., FACEBOOK, TWITTER, email, etc.), thus allowing users to share news, events, awards, new videos, favorite videos, etc. Alternatively, a bulletin board/forum sharing mechanism allows for collaborative conversation and/or constructive criticism between users. (Admins may add/edit/delete categories, and delete posts of other users.)

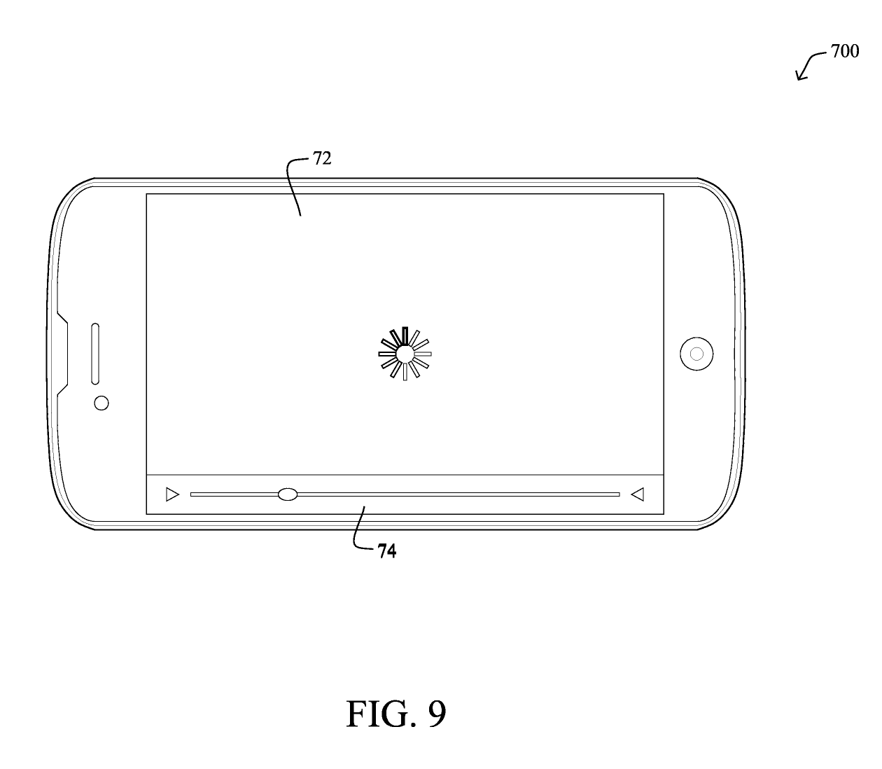

According to one or more embodiments herein, when a user plays a video, as shown in the display 700 of FIG. 9, the video 72 may be forced to display in “landscape” mode (i.e., where the aspect ratio of the video is wider than it is tall, and generally fills the widescreen dimensions of the viewing device). In particular, forcing the app to play videos in “landscape” mode (as will be understood in the art) provides an environment that more easily displays videos in their intended “widescreen” format, without requiring the user to properly rotate their mobile device (or worry about having the videos resort to “portrait” mode while moving their mobile device or placing it on a horizontal surface). A status bar 74 may also inform the user of the approximate location within the playing video, and gives the user the typical options to start/stop/pause and/or control the volume of the video.

Note that the techniques herein may provide for user-specific interaction based on a standard login, or else may be on a unique device identifier (UDID) basis. That is, each device (e.g., mobile phone) has a UDID, and thus the app does not require users to login so a favorite list and votes may be stored on the UDID basis. Also, in one embodiment, a particular user (login and/or UDID) may only vote for a particular video (e.g., like, +1, etc.) one time. On the other hand, each time a video is viewed, regardless of whether it was the same user or UDID, this may be counted toward the value of total views (e.g., if viewed by the same person on the same device ten times, the system may be configured to count one view based on UDID, or else counts each view individually, thus counting ten views).

As mentioned above, an administrator may receive notification of receipt and/or viewing of the video, that is, confirmation that the user received the push/email, and also (or alternatively) a confirmation that the user actually watched the video. In this instance, the user's login or UDID may be used to associate the particular user with a device that viewed the video, and as such, a secure messaging confirmation of the video being watched by each user may be sent to the administrator (or else included in an updated database entry that may be searched by the administrator). The notification and/or database may contain one or more of login information, UDID mappings to user names, etc., in order to assist an administrator that is monitoring the viewership of the videos.

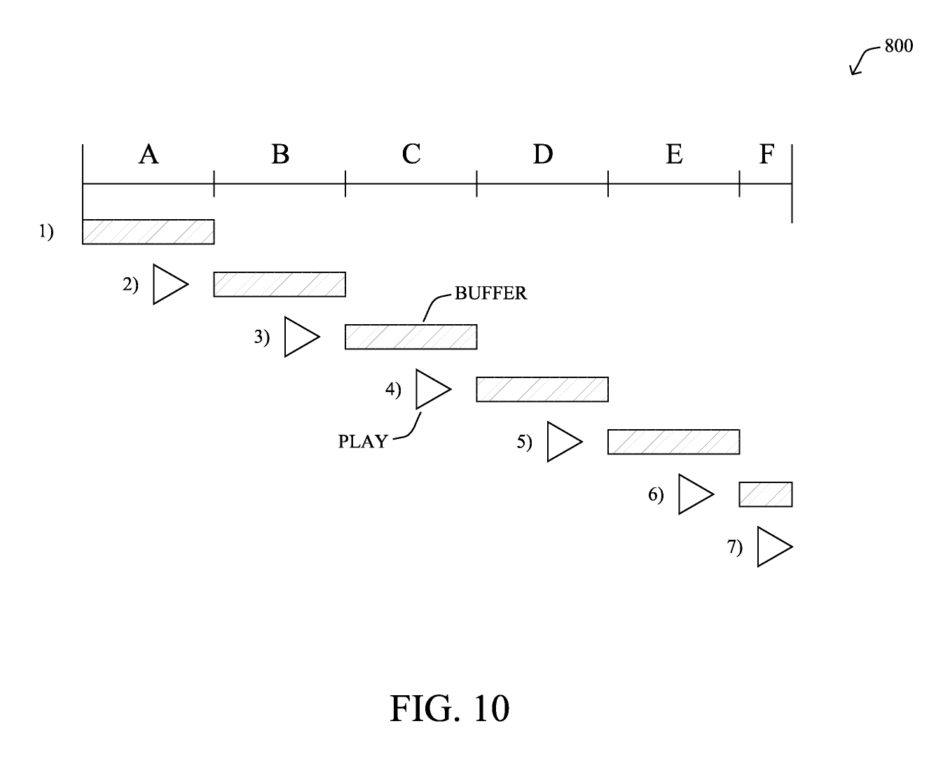

According to one or more embodiments of the present invention, videos may be pre-loaded or “pre-buffered” to avoid download time for the viewer. For example, with reference to graph 800 of FIG. 10, data can be downloaded in batches of n seconds (e.g., 15 seconds), thus parsing the length of a video into segments, such as A-F as shown (where F is less than n seconds). After an initial buffering period “1)” for a first segment (e.g., segment A), each time the pre-buffered segment is playing, the next segment is being buffered (e.g., buffering segment B while segment A is playing in step “2)”). Note that if a video is less than n seconds, one embodiment is configured to download the segment completely before initiating playing of that segment. Pre-buffering in this segmented manner provides for a better viewing experience when network connectivity might be sub-optimal, since it may be perceived to be a better experience to view n seconds of video and then pause while more data is buffered, rather than being “jerky” by playing a second, pausing for three, playing for another five, pausing for one, and so on.

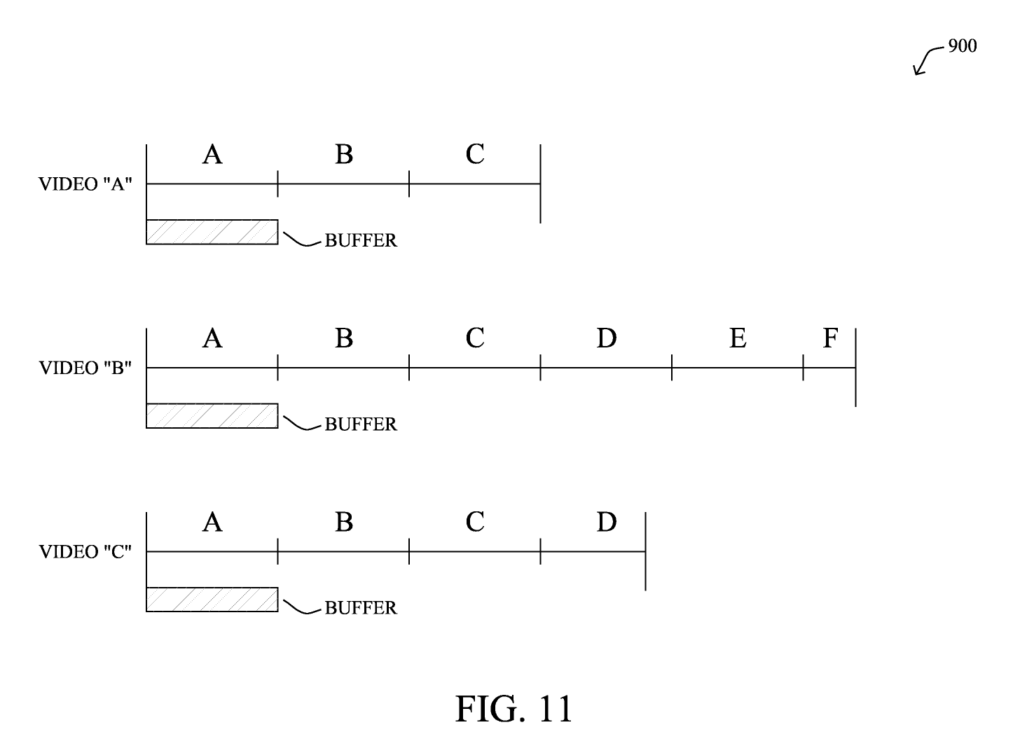

Note further that pre-buffering of video content based on displayed video lists (e.g., thumbnails) provides for even less user wait-time when selecting a desired video to play. For instance, with reference to graph 900 of FIG. 11, assume that Video “A”, “B”, and “C” were displayed in a list of videos, such as the list in FIG. 7 or FIG. 8 above. While the user is perhaps reading the synopsis, looking at the details, and generally deciding whether to play the video, the techniques herein may already begin pre-buffering the video that is selected (e.g., 61) as well as the related videos (e.g., 62), such that when the user selects one of the currently selectable videos to watch (he or she can only select what is shown in the screen), the selected video may have already begun downloading.

As mentioned above, advertisements may consist of one or more of banner ads (e.g., each ad may be displayed for 30 seconds and then rotate), background ads (e.g., provided by an ad agency and/or uploaded manually by the administrator), and pre-roll ads (i.e., played before the video starts on the video player). In the case of pre-buffering, however, the ads may also be pre-buffered or else may be stored locally, and played while the pre-buffering of the selected video occurs. In other words, a 15-second (or n-second) advertisement video may be played during the first 15-second (or n-second) buffering interval of the selected video in order to allow the video to load, while also offering an advertising opportunity within the platform.

The amount of video consumed today suggests it is the preferred method of consumption by users. The enhanced mobile video platform described herein may thus benefit a variety of different scenarios for users/consumers. For example, with reference to the examples below, business audiences, education faculty and students, and filmmakers (producers, directors, etc.) can each benefit from the novel features described herein, such as for training and knowledge (e.g., videos and/or links regarding training), as well as entertainment. In particular, the techniques herein provide the ability to send information to users world-wide in real-time, with content delivered in a native language of the country of origin (or destination), or even based on the individual recipient's preferred language. Disseminating video-based information in this manner, particularly for training, education, and entertainment, provides a more “user-friendly” technique than conventional methods.

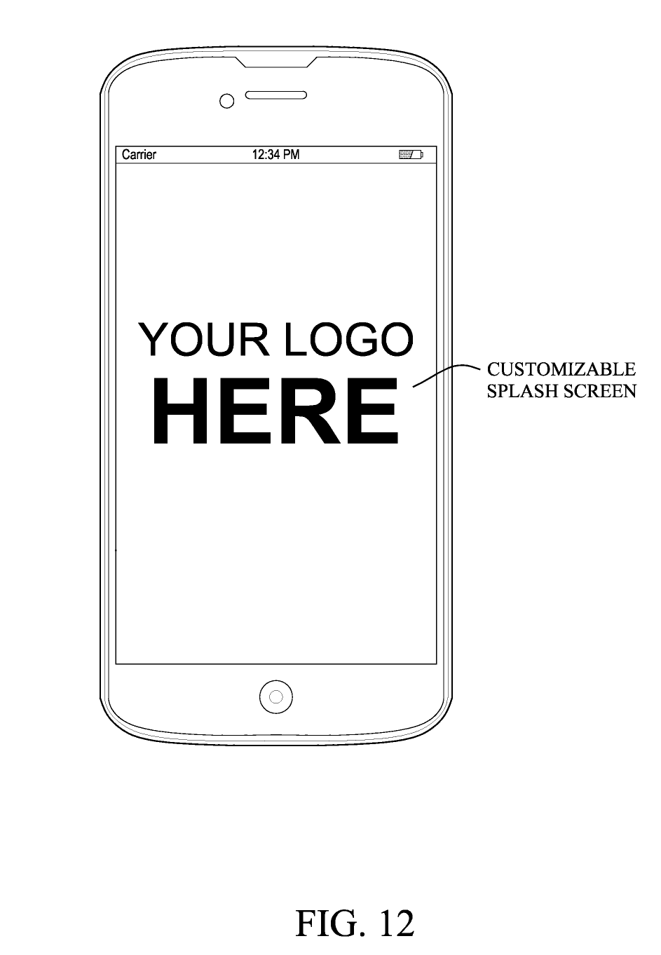

Accordingly, the enhanced mobile video platform described herein may be specifically tailored for different purposes, and even for different sponsors/vendors of the video. For instance, as shown in FIG. 12, a “splash logo” (introductory image while the program loads) may be configured with any corporate logo, educational institution logo, etc., and the remainder of the interface may also be tailored with trim, colors, and logos corresponding to the particular sponsor.

For example, assume a world-wide retailer has configured the mobile video platform to communicate with their employees for training and general information sharing. As such, the splash logo in FIG. 12 may be configured to show the corporate logo for the retailer.

Continuing this example, assume that an employee user can access videos in one of two ways. First, an employee may receive a push notification as shown in

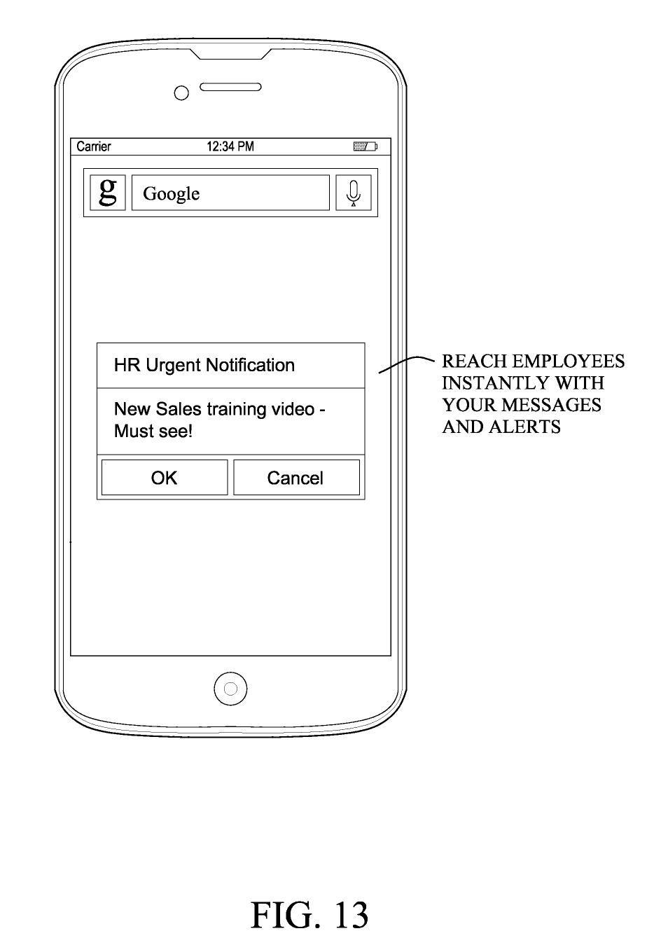

FIG. 13 to their mobile device, indicating that a new video is available, and that perhaps requires his or her viewing. (Note that email notification is also possible for the techniques herein.) For instance, a new company policy may have been released, a departmental procedure may have been updated, or even a seasonal greeting message could be relayed. In accordance with the techniques herein, such a pushed video may be associated with confirmation that the user received the push/email, and also (or alternatively) a confirmation that the user actually watched the video. In this manner, a manager or other administrator could determine who has and who has not yet viewed the material.

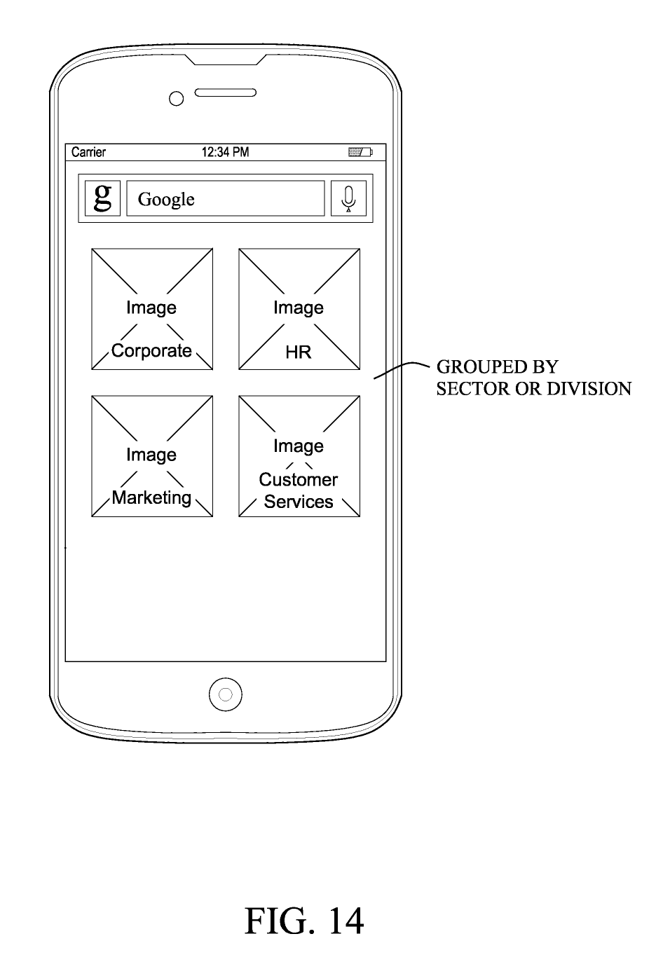

Alternatively, for corporate business configurations, employees may also go through a navigation page/window, such as shown in FIG. 14, to select a particular group or category corresponding to a set of videos he or she would like to browse.

For instance, example groups (e.g., sectors or divisions) as shown in FIG. 14 may comprise a “Corporate” link, an “HR (Human Resources)” link, a “Marketing” link, and a “Customer Services” link. Any different category may be made available, and the number of categories is also configurable.

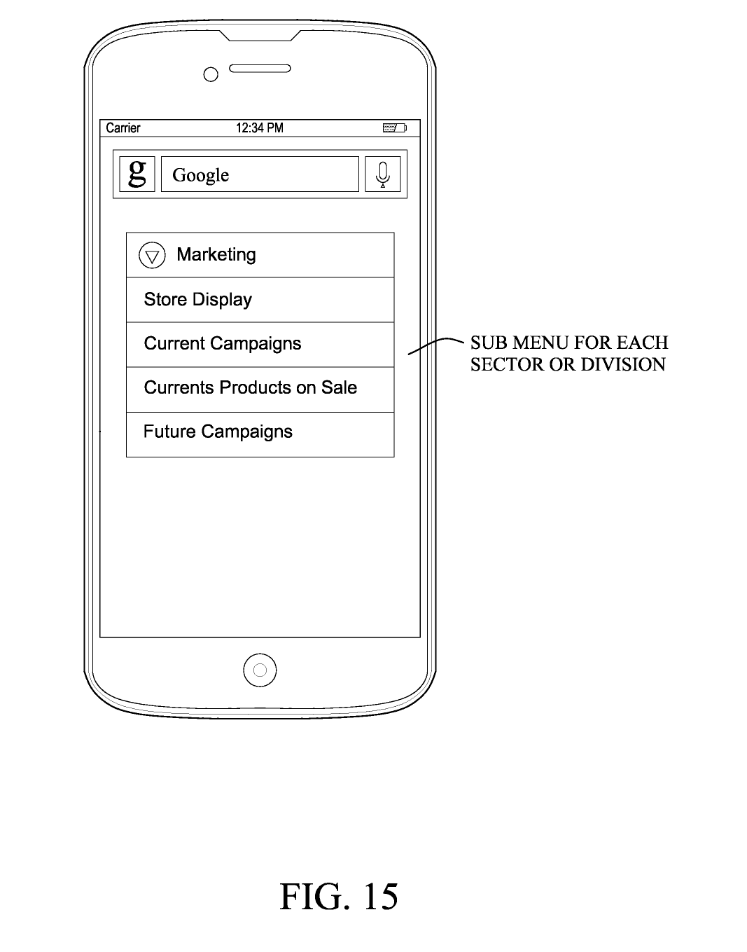

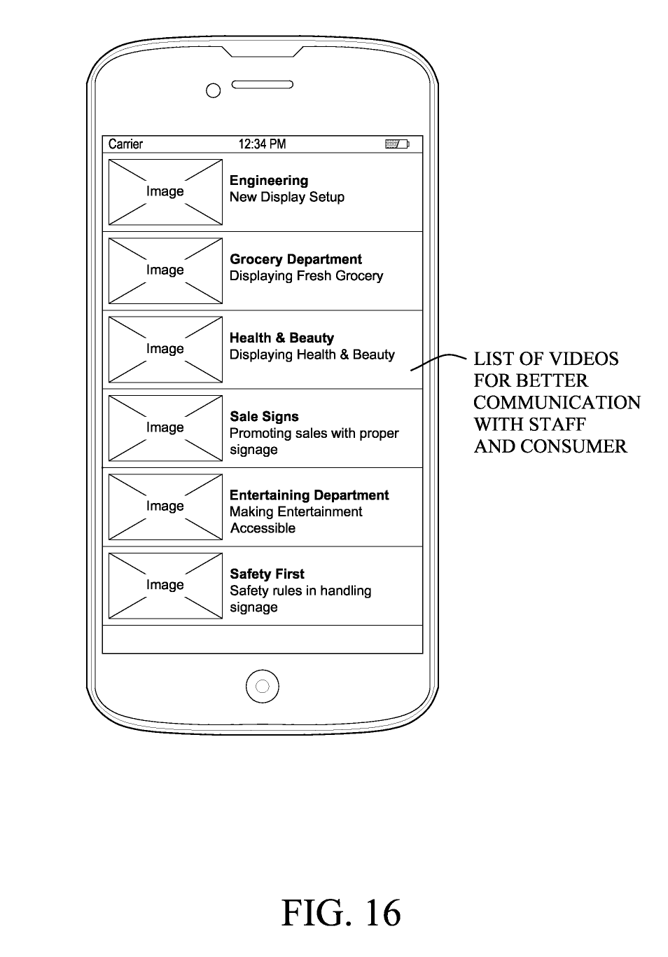

By selecting one of the groups, for example, “Marketing”, the employee may be brought to a new screen, such as that shown in FIG. 15, where a sub-menu of available categories may be presented based on the initially-selected group (e.g., for marketing, perhaps store displays, current/future campaigns, products on sale, etc.). If “Store Display” is selected in FIG. 15, then an illustrative listing of videos and thumbnails relating to displays, signs, etc. may be presented as shown in FIG. 16.

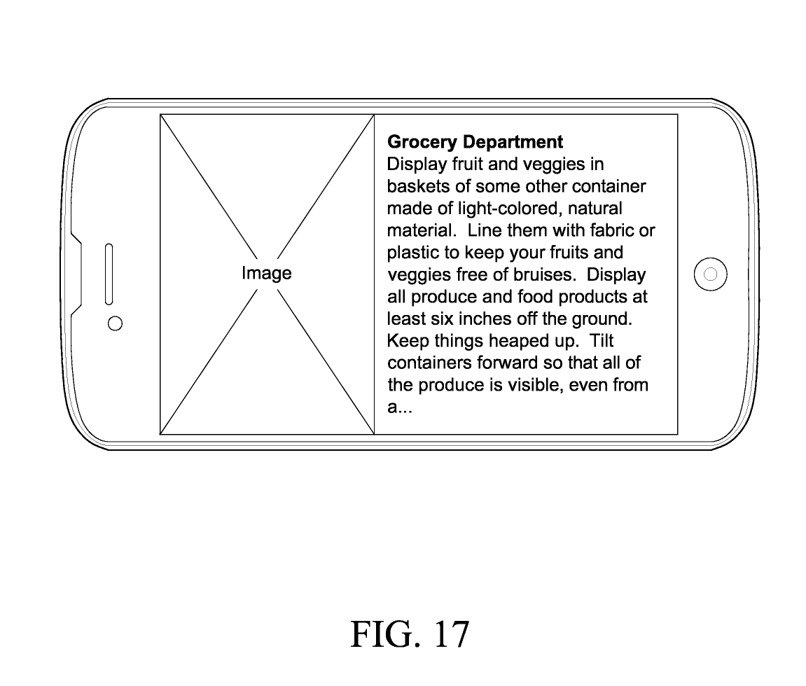

Once one of the videos is selected, such as the one relating to the Grocery Dept., a new screen as shown in FIG. 17 may be brought up, illustratively in landscape mode, providing information about the selected video (e.g., a thumbnail and a synopsis or other information). From this screen, the user can decide to watch the selected video, and the video is played according to the techniques described above.

Truly, any method to browse for videos may be used, such as search boxes, recent videos, un-seen videos, videos specific to the employee (e.g., department, training level, etc.) may be used herein. Also, the number of different “drill-down” selections (e.g., group, to sub-menu, to video list, to video synopsis, to video play) may also be different (more or less), depending upon the arrangement desired by the administrator.

Moreover, in one embodiment of business content, the video to be played is directed to a product on sale at a store location associated with the client device. In a specific implementation of this embodiment, a mobile device may be able to scan the product (e.g., a barcode, image, QR-code, etc.), and be directed to a video associated with the product (e.g., marketing, instructions, display, training, etc.). For instance, the server may store a plurality of videos associated with products, and when a mobile device scans a particular product identifier, it may specifically request any videos associated with that product that are stored on the server, accordingly.

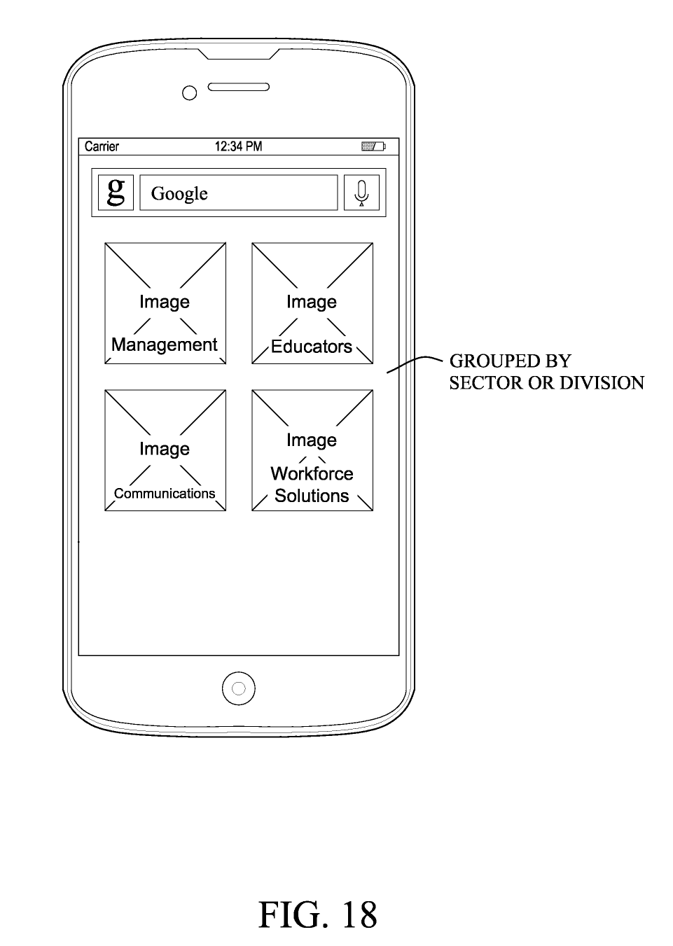

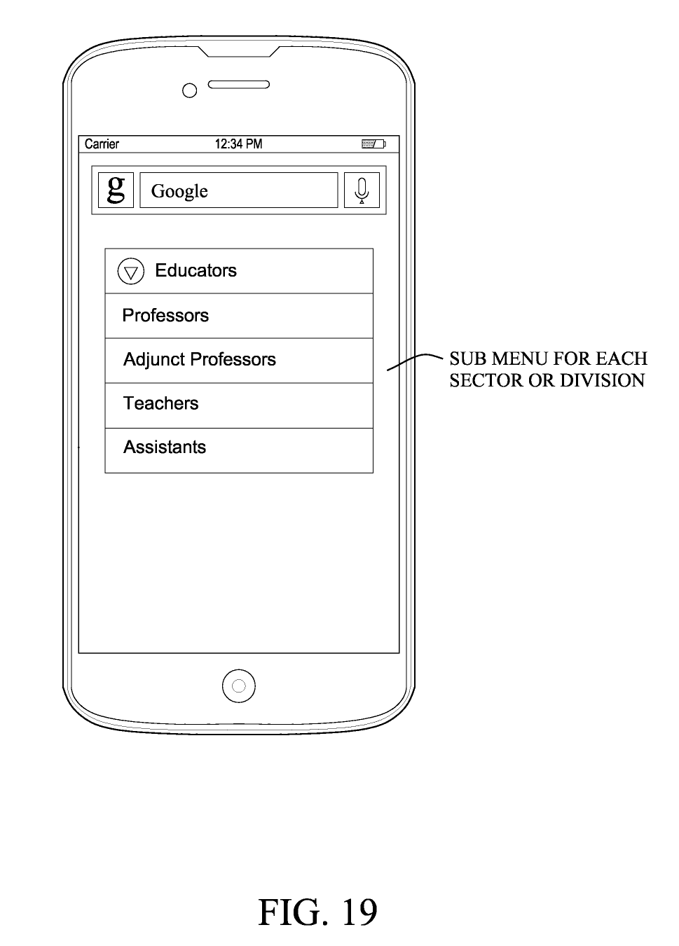

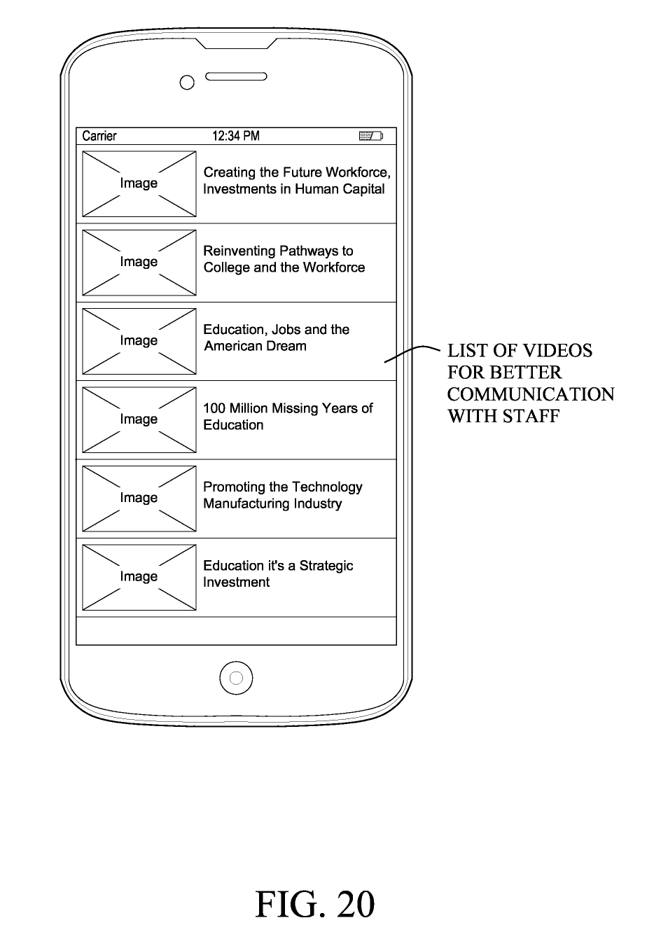

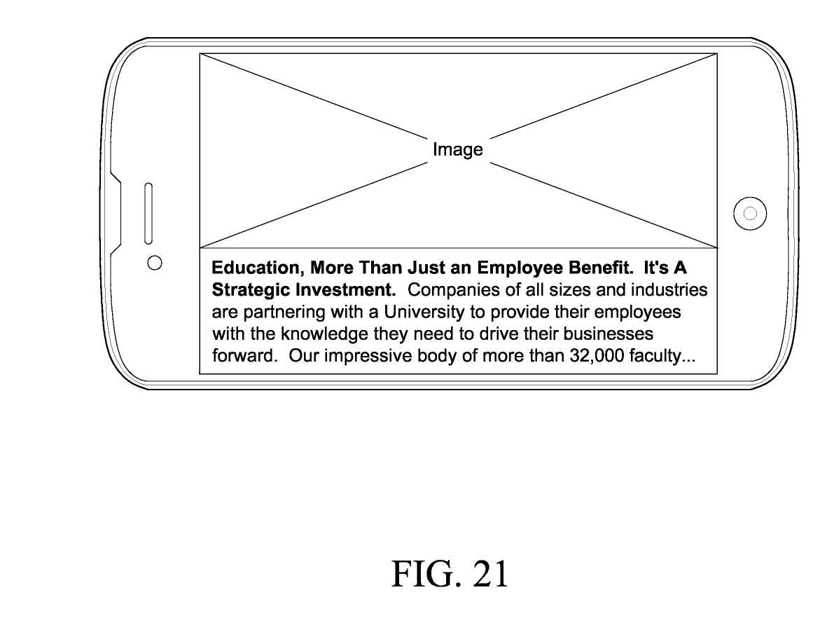

Notably, the techniques herein are equally applicable to education, such as shown with reference to FIGS. 18-21. Here, instead of a corporate/retail set of menus, an alternative set may be based on the needs of the educational institution, such as dividing access and/or groups into management, educators, students, etc. Sub menus would also reflect the different design of an educational administrator, such as dividing Educators into Professors, Adjunct Professors, Teachers, Assistants, and so on.

In addition, the platform described herein may also be particularly useful for the socially creative and collaborative filmmaking industry (producers and directors, as well as film consumers). For instance, in addition to sorting videos by director as mentioned above, sorts based on cast, awards, genres, etc., may also be configured within the system described herein. Also, greater connection with filmmakers may be afforded by providing filmmaker profiles, such as where users can see a filmmaker's name, photo, and description, as well links to uploaded videos and publically available scripts by the filmmaker. Note that filmmakers and/or users can request a script, such as by posting a comment. Also, in one embodiment, filmmakers can reply to a request and upload a script which can be made public or private (user can pick a set of people who can read and download the script. Others will only see first page of the script. User can enter emails of the people he wants to allow to see the script. These people will receive an email along with a link to script.)

Various video/filmmaking events (e.g., with title, description, photo, date, etc.) may be listed and searchable by date, location, purpose, etc. Moreover, videos may be shortlisted to be played in a “projection festival”, where competitions may produce winners, whose picture and description may be presented to users of the platform. When a user clicks on it, he/she is redirected to video that was uploaded by the user to compete. Archival of winners (e.g., segregating data by winners in different years) is also available. Awards, award descriptions, award recipients, etc., may be presented to users of the platform and edited by an administrator. In one embodiment, a listing of the judges for these competitions may be edited by an administrator and made available to users of the platform (e.g., adding/editing/deleting judges' picture, title, and text).

Other uses, implementations, and configurations of the video platform described herein are of course feasible, and those listed herein are merely a representative sub-set of the possibilities. As such, the examples given for business, education, and filmmaking are not meant to limit the scope of the present disclosure.

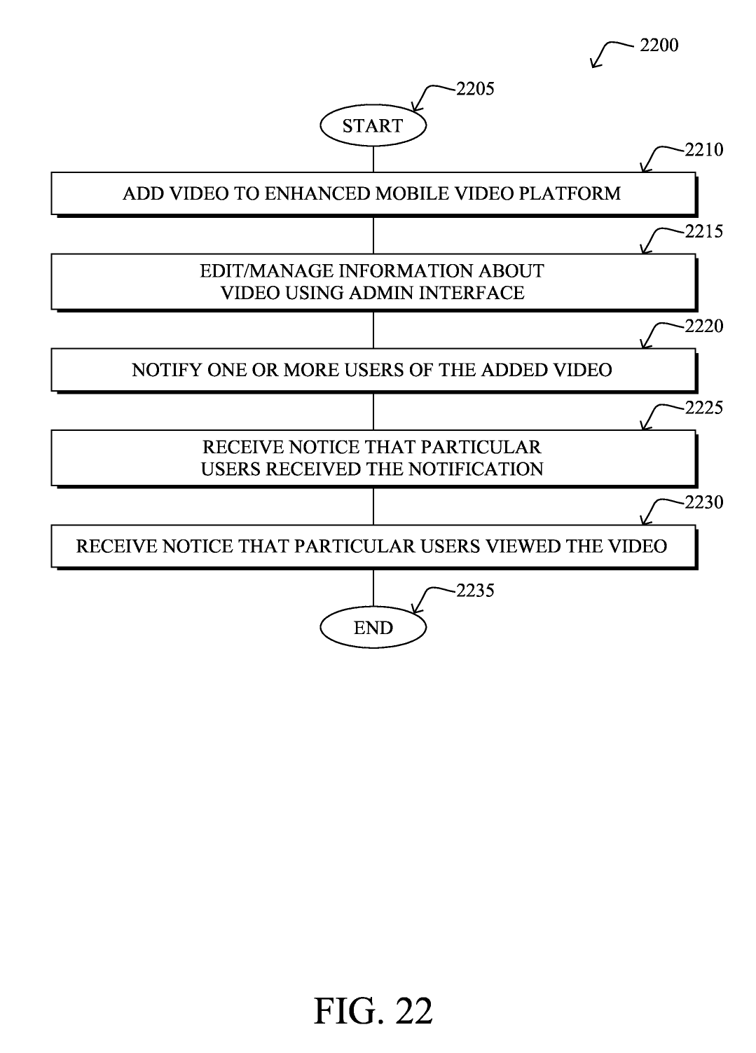

FIG. 22 illustrates an example simplified procedure 2200 for certain key features associated with providing an enhanced mobile video platform in accordance with one or more embodiments described herein, particularly from the perspective of a video administrator. The procedure 2200 may start at step 2205, and continues to step 2210, where, in one embodiment as described in greater detail above, a video is added to the enhanced mobile video platform. Accordingly, in step 2215, the administrator can then edit/manage information about video using the administrator's interface, and then may trigger notifying of one or more users of the added video (e.g., select users, subscribers, students, employees, groups, etc.) in step 2220. As particular users receive the notification, in step 2225 the administrator receives notice to that effect, and may also receive notice that particular users viewed the video in step 2230. The simplified procedure 2200 ends in step 2235.

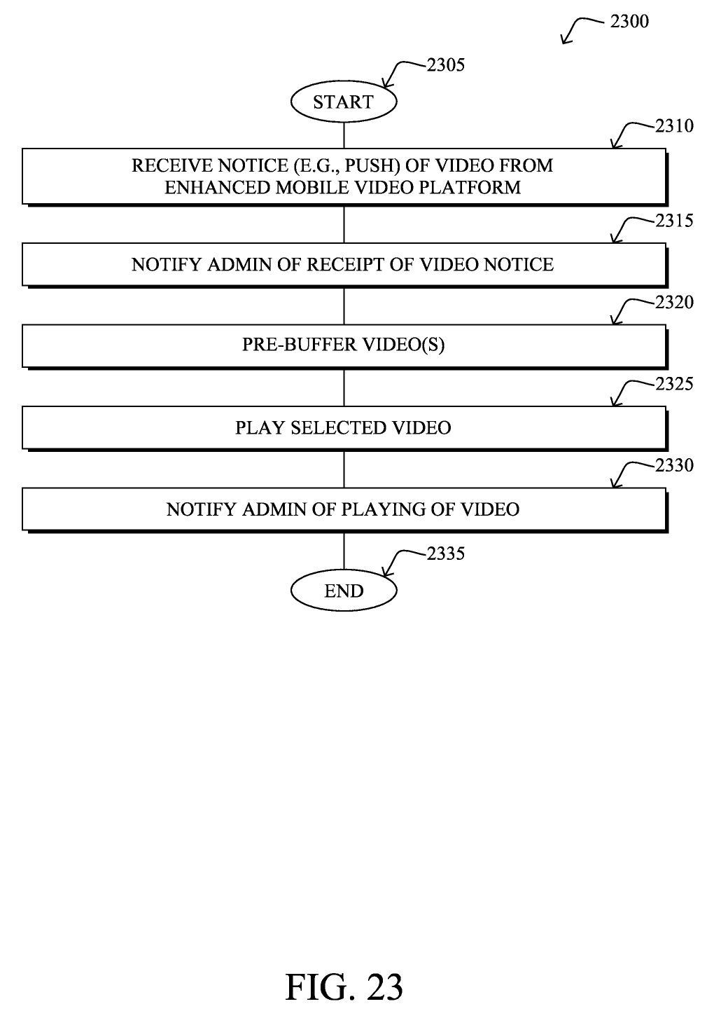

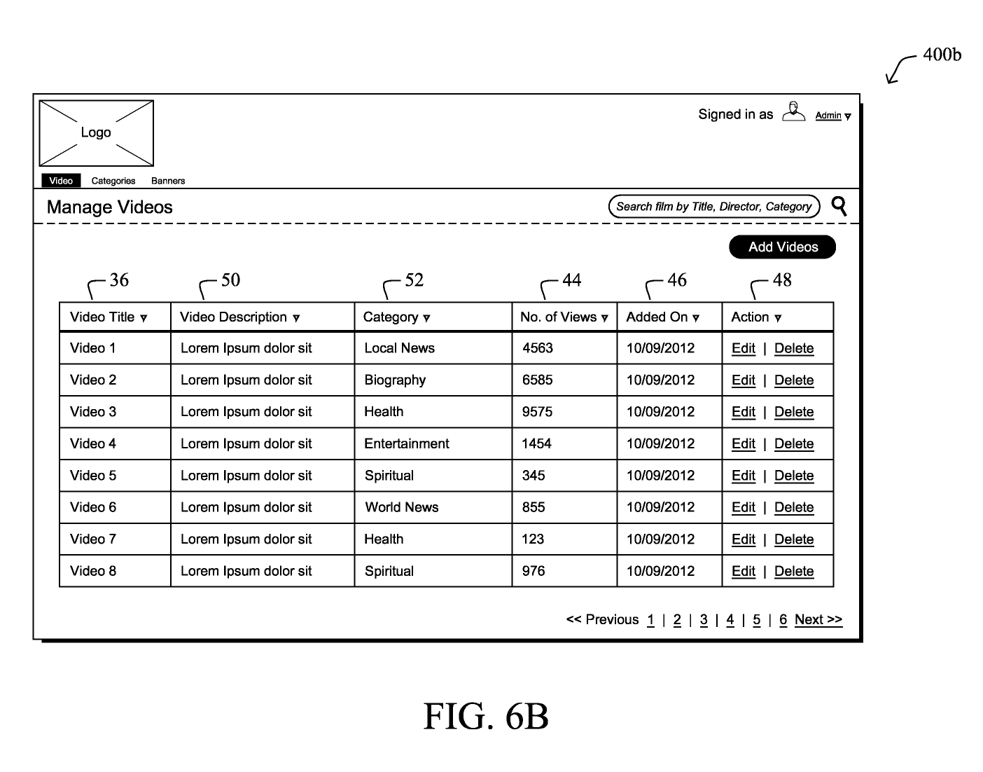

Additionally, FIG. 23 illustrates another example simplified procedure 2300 for certain key features associated with providing an enhanced mobile video platform in accordance with one or more embodiments described herein, particularly from the perspective of a user's video player. The procedure 2300 may start at step 2305, and continues to step 2310, where, in one embodiment as described in greater detail above, a user's video player (e.g., app) may receive notice of a video from the enhanced mobile video platform, such as in the form of a push notification or an email. Once the video player receives the video, then in step 2315 it notifies an administrator of receipt of video notice, and may either begin to pre-buffer the video in step 2320, or else waits for the user to accept/open the video before pre-buffering. (Note that in one embodiment, multiple videos are pre-buffered, such as based on a list view of the multiple videos, as mentioned above.) In step 2325, the video player may play the selected video, and notifies the administrator of the playing of the video in step 2330. The simplified procedure 2300 then ends in step 2335.

Notably, the procedures 2200-2300 represent specific embodiments, and are not meant to describe the entire scope of the disclosure. For instance, an administrator can select thumbnails, pick related videos, establish selectable genres/categories, etc. Also, a user can browse/search for videos (rather than receiving a notice), such as scanning the product for an associated video to be accessed, and may vote on the video, share the video, add the video as a favorite, and so on.

It should also be noted that while certain steps within procedures 2200-2300 may be optional as described above, the steps shown in FIGS. 22-23 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 2200-2300 are described separately, certain steps from each procedure may be incorporated into each other procedure, and the procedures are not meant to be mutually exclusive.

Advantageously, the techniques herein provide an enhanced mobile video platform. In particular, the architecture and features of the mobile video platform herein provides users and content providers with an enhanced experience, such as through pre-buffering, forced “landscape” mode. In addition, features specifically tailored for business and/or educational purposes can increase sales revenues and decrease operational costs, putting information in the hands of the employees/students when and where they need it (“What you want, When you want it”™). Also, the techniques and systems herein provide the ability to disseminate training information with a more user-friendly program format, where content can be delivered in the native language of the user (or the country of origin/destination). Lastly, as mentioned above, the techniques and platform herein follow the content throughout the chain of administrators and users through secure messaging and confirmation of content reception and viewing.

While there have been shown and described illustrative embodiments that provide an enhanced mobile video platform, it is to be understood that various other adaptations and modifications may be made within the spirit and scope of the embodiments herein. For example, the embodiments have been shown and described herein with relation to mobile apps for smartphones and/or tablets in general. However, the embodiments in their broader sense are not as limited, and may, in fact, be used with other types of devices, such as PC-based websites as well.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
receiving, at a video player application of a client device, an indication of a particular video added to a video platform;
receiving the particular video at the video player application from the video platform;
responsive to at least one of either receiving the indication or receiving the particular video, returning a receipt notification to the video platform from the video player application;
playing the particular video at the video player application; and
responsive to playing the particular video, notifying the video platform that the particular video has been played by the video player application.

2. The method as in claim 1, wherein the indication is at least one of an email and a push notification to the client device.

3. The method as in claim 1, wherein the video added to video platform requires viewing by the receiving video player application.

4. The method as in claim 1, further comprising:
subscribing the video player application to one or more categories of videos, wherein the video platform sends the indication of the particular video to the video player application in response to the particular video belonging to a category within the one or more categories of videos to which the video player application is subscribed.

5. The method as in claim 1, wherein the video player application is associated with a user that belongs to one or more categories, wherein the video platform sends the indication of the particular video to the video player application in response to the particular video belonging to a category within the one or more categories to which the user belongs.

6. The method as in claim 1, further comprising:
associating the video player application with one or both of a specific user login and a unique device identifier (UDID).

7. The method as in claim 6, further comprising:
soliciting and returning feedback for the video player application associated with the specific user login or UDID, respectively.

8. The method as in claim 1, wherein notifying the video platform that the particular video has been played by the video player application causes one of either a notification to an administrator or an updated database entry searchable by the administrator.

9. The method as in claim 1, further comprising:
pre-buffering the particular video by the video player application prior to playing the particular video.

10. The method as in claim 9, wherein pre-buffering is performed based on receiving the indication of the particular video being added to the video platform.

11. The method as in claim 9, wherein pre-buffering is performed based on the particular video being displayed on the client device within a list of available videos to play, wherein pre-buffering comprises pre-buffering the particular video and one or more other videos within the displayed list.

12. The method as in claim 9, wherein pre-buffering is performed based on displaying information about the particular video prior to receiving user instruction to play the particular video.

13. The method as in claim 9, wherein pre-buffering comprises:
buffering the particular video in segments, where each subsequent segment is buffered during playback of the previous segment.

14. The method as in claim 9, wherein pre-buffering comprises:
buffering the particular video in its entirety prior to playing the video in response to the particular video being shorter in length than a predefined length of time.

15. The method as in claim 9, wherein pre-buffering is performed during playing of a video advertisement by the video player application prior to playing the particular video.

16. The method as in claim 1, further comprising:
pre-buffering a video advertisement prior to user selection to play the particular video; and
playing the video advertisement prior to the particular video in response to receiving the user selection to play the particular video.

17. The method as in claim 1, further comprising:
forcing the particular video to play in a landscape mode on the client device.

18. The method as in claim 1, wherein the particular video has a plurality of available language options for one or both of audio or visual content of the particular video, and wherein the particular video is received by the video player application with an associated language based on one or more language considerations of the video player application, the language considerations selected from a group consisting of: a preferred language of an associated user of the video player application; a default language of a geographical region in which the video player application is located;
and a default language of the particular video.

19. The method as in claim 1, wherein the particular video is directed to a product on sale at a store location associated with the client device.

20. The method as in claim 19, further comprising:
scanning, by the client device, an identification of the product; and
requesting the particular video from the video platform based on the identification of the product.

21. The method as in claim 20, wherein the identification of the product is selected from a group consisting of: a barcode of the product, an image of the product, and a QR-code of the product.

22. A method, comprising:
receiving a particular video at a video platform;
determining one or more video player applications of one or more associated client devices to receive the particular video;
sending an indication of the particular video from the video platform to the one or more video player applications of one or more associated client devices to receive the particular video;
sending the particular video from the video platform to one or more of the one or more video player applications;
receiving one or more returned receipt notifications at the video platform from one or more of the one or more video player applications responsive to a corresponding video player application at least one of either receiving the indication or receiving the particular video; and
receiving one or more notifications at the video platform from one or more of the one or more video player applications responsive to a corresponding video player application playing the particular video.

23. A method, comprising:
scanning, by a client device, an identification of a product;
requesting, by a video player application of the client device, a video directed to the product from a video platform;
receiving, at the video player application from the video platform, a particular video based on the product; and
playing the particular video at the video player application.
